(19) United States
(12) Patent Application Publication
(10) Pub. No.: US 2009/0128281 A1
(43) Pub. Date: May 21, 2009

(54) COMPOSITE CHIP VARISTOR DEVICE AND METHOD OF MANUFACTURING THE SAME

(75) Inventor: YUNG-CHI CHEN, Miaoli (TW)

Correspondence Address: WPAT, PC;INTELLECTUAL PROPERTY ATTORNEYS, 2030 MAIN STREET, SUITE 1300, IRVINE, CA, 92614, US

(73) Assignee: INPAQ TECHNOLOGY CO., LTD., Miaoli (TW)

(21) Appl. No.: 12/035,790

(22) Filed: Feb. 22, 2008

(30) Foreign Application Priority Data
Nov. 20, 2007 (TW) 096143976

(51) Int. Cl. H01C 7/10; H01C 17/02

(52) U.S. Cl. 338/20; 29/619

(57) ABSTRACT

A composite chip varistor device includes a body; at least one inner varistor, disposed in the body; and a plurality of end electrodes, disposed at two sides of the inner varistor. The body is a highly insulative and imporous mono-material. The body of the present invention provides protection for the inner varistor to avoid being damaged by external factors and the manufacturing cost of the varistor device is effectively reduced.

### BACKGROUND OF THE INVENTION

1. Field of the Invention

The present invention relates to a varistor device, and more particularly to a composite chip varistor device.

2. Description of the Prior Art

In the prior art, major components of a varistor include SiC, SrTiO₃, and ZnO systems, in which the ZnO chip varistor is the most widely utilized. The additives to the ZnO chip varistor may be Pr base, Bi₂O₃ base, and V₂O₅ base, and the variable-characteristic of the ZnO chip varistor during densification sintering process.

According to Japanese Laid-open Patent Publication No. 2002-246207, a Pr base ZnO varistor attains the variable characteristic after being densification sintered at 1200° C. As the sintering temperature is too high, when fabricating a chip device, an inner electrode must be made of an expensive metal, such as Pd or Pt metal, thus leading to the extremely high cost.

According to Taiwan Patent Publication No. 207027, a Bi₂O₃ base ZnO varistor attains the variable characteristic after being densification sintered between 950° C. to 1300° C.

According to Taiwan Patent Publication No. 345665, a V₂O₅ base ZnO varistor attains the variable characteristic after being densification sintered between 900° C. to 950° C. However, the variable characteristic thereof is slightly weaker than that of the Pr base or Bi₂O₃ base ZnO varistor.

During the electroplating processs, as the electroplating solution is usually a high acid/alkaline solution, the surface of the body of the chip varistor device may easily be affected by the electroplating solution, and thus lose its originally designed electrical characteristics.

Since the chip varistor device is semi-conductive property, during the electroplating, an undesired electroplated layer is usually generated on the surface of the device, and causes failure of the device.

Further, if being in direct contact with moisture, the semi-conductivity property of the device may greatly reduce the reliability of the device in use and decrease life of the device. Therefore, most of the chip varistor device manufacturers have an insulating protective layer on the surface of the device.

The insulating protective layer may be fabricated by the following materials and methods.

(1) The first method: according to Taiwan Patent Publication No. 1269618, an insulating protective film is formed on the surface of a body of a laminated passive device, and the material of the insulating protective film is an amorphous material (for example, glass), a polymer material, or the like. After the insulating protective film is formed, a stripping and cleaning process is used to expose the inner electrode. Then, an outer electrode termination process is performed to achieve the purpose of protecting the body, and to facilitate the subsequent process of electroplating a soldering interface layer. Due to an additional stripping and cleaning process is added, the materials and equipments related to this step must carefully selected, thus causing difficulties in fabricating.

(2) The second method: first, an insulating protective film is formed on the surface of a body of a laminated passive device in a manner of film growing, which achieves the same effect of the above method, and meanwhile avoids adding the stripping and cleaning process, thus reducing the fabrication time and the cost. However, in this method, after the IR reflow or wave soldering process, the insulation resistance value will be decreased. That is, when the device is mounted on an electrical loop, the leakage current will be increased, and thus effect the reliability of the product. Besides, it is difficult to control the process of achieving high resistance on the surface, and the deficiency of poor insulation may occur. Therefore, it is an important subject to provide a method of forming a stable insulating protective film on the surface of the body without producing any reaction with the body.

(3) The third method: a high-resistance insulating protective film is formed on the surface of the device in a manner of metal diffusion. This method is carried out by controlling the diffusion of metal ions, and is thus the most difficult one. It is hard to control the parameters of achieving high resistance on the surface, and since the equipment is semi-conductive the manufacturing cost is very high.

In view of the above methods, the prior art is not good and has many defects, so is in need of improvement.

### SUMMARY OF THE INVENTION

Accordingly, in order to solve the above defects in the prior art, a composite chip varistor device including a body, at least one inner varistor disposed in the body is provided. The inner varistor has two ends, and a plurality of end electrodes disposed at the two ends of the inner varistor. The body is a highly insulative and imporous mono-material.

The present invention further provides a method of manufacturing a composite varistor device. The method includes the following steps. First, an inner varistor is formed. Then, a plurality of end electrodes is formed at two ends of the inner varistor. The inner varistor and the plurality of end electrodes are placed in the body. A body having a highly insulative and imporous mono-material is formed.

### BRIEF DESCRIPTION OF THE DRAWINGS

FIG. 1A is a three-dimensional view of a composite chip varistor device according to an embodiment of the present invention;

FIG. 1B is a schematic cross-sectional view of the varistor device in FIG. 1A;

FIG. 2A is a schematic view of an inner varistor according to an embodiment of the present invention;

FIG. 2B is a schematic view of an inner varistor according to another embodiment of the present invention; and

FIG. 3 is a schematic cross-sectional view of a composite chip varistor device according to another embodiment of the present invention.

### DETAILED DESCRIPTION

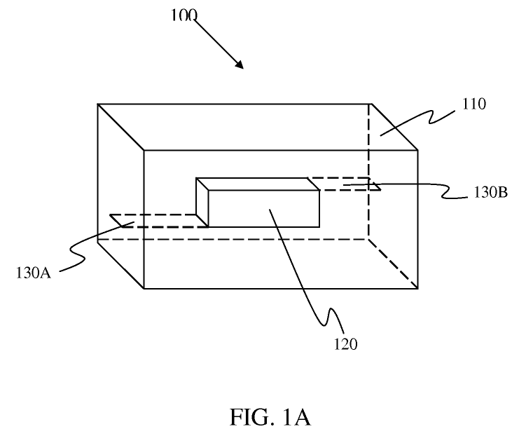

Referring to FIG. 1A, a three-dimensional view of a composite chip varistor device 100 according to an embodiment of the present invention is shown. The composite chip varistor device 100 includes a body 110, an inner varistor 120, and two end electrodes 130A, 130B. FIG 1B is a schematic cross-sectional view of the varistor device 100 in FIG. 1A.

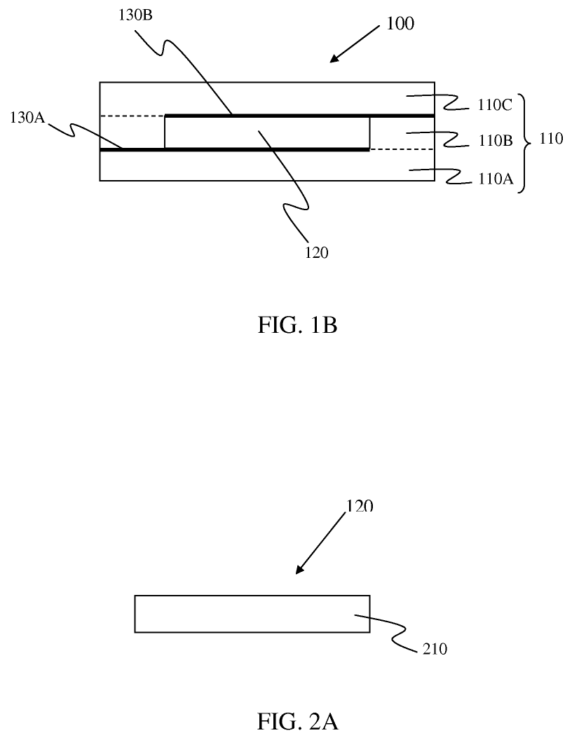

Referring to FIG. 2A, a schematic view of the inner varistor 120 according to an embodiment of the present invention is shown. The inner varistor 120 is fabricated by the following steps. First, a binder is added to the varistor powder to form an inner varistor strip 210. Then, the inner varistor strip 210 is cut into a desired size. Finally, the inner varistor strip 210 is sintered at a temperature above 1000° C. to obtain desired variable characteristics. FIG. 2B is a schematic view of the inner varistor 120 according to another embodiment of the present invention. In this embodiment, the upper and lower surfaces of the inner varistor strip 210 are respectively printed with a conductive layer, thus forming an inner electrode 220. The inner varistor strip 210 is a Pr base or Bi₂O₃ base ZnO chip varistor. The inner electrode 220 is made of a metal material of Ag, Pd, Pt, or an alloy material thereof. The thickness of the inner electrode 220 may be 10 nm to 0.5 mm, the cutting length and width may be 1 mm to 10 mm, and the thickness of the inner varistor strip 210 may be 10 μm to 1 mm.

Referring to FIG. 1B again, the composite chip varistor device 100 is fabricated by multilayer printing or laminated.

In the multilayer printing, first, an insulating material is printed or stacked to form a lower layer 110A of the body. Then, a conductive layer is printed to form the end electrode 130A. The inner varistor 120 is placed at the middle position. In addition, according to the above illustration, the inner varistor 120 further includes an inner electrode 220. Afterwards, an insulating material is covered around the inner varistor 120 to form an interlayer 110B of the body. Then, a conductive layer is printed to form the other end electrode 130B. Finally, an insulating material is printed to form an upper layer 110C of the body. Thereafter, the whole structure is sintered or cured at a temperature of 200° C. to 1000° C., so as to form the body 110. The end electrodes 130A, 130B are made of a metal material of Ag, Pd, Pt, Cu, or an alloy material thereof. The thickness of the end electrodes is 0.1 μm to 1 mm. The body 110 is made of an insulating ceramic material or a polymer material, which is sintered or cured at a temperature of 200° C. to 1000° C., such that the body is a highly insulative and imporous mono-material.

In the laminated, first, an insulating material is used to prepare an upper layer 110C and a lower layer 110A of the body. A conductive layer is respectively printed on the upper layer 110C and the lower layer 110A of the body, so as to form the end electrodes 130A, 130B. The inner varistor 120 is placed at the middle position. After that, an insulating material is covered around the inner varistor 120 to form an interlayer 110B of the body. Finally, the whole structure is laminated to form the body 110. The end electrodes 130A, 130B are made of a metal material of Ag, Pd, Pt, Cu, or an alloy material thereof. The thickness of the end electrodes is 0.1 μm to 1 mm. The body 110 is made of an insulating ceramic material or a polymer material, which is sintered or cured at a temperature of 200° C. to 1000° C., such that the body is a highly insulative and imporous mono-material.

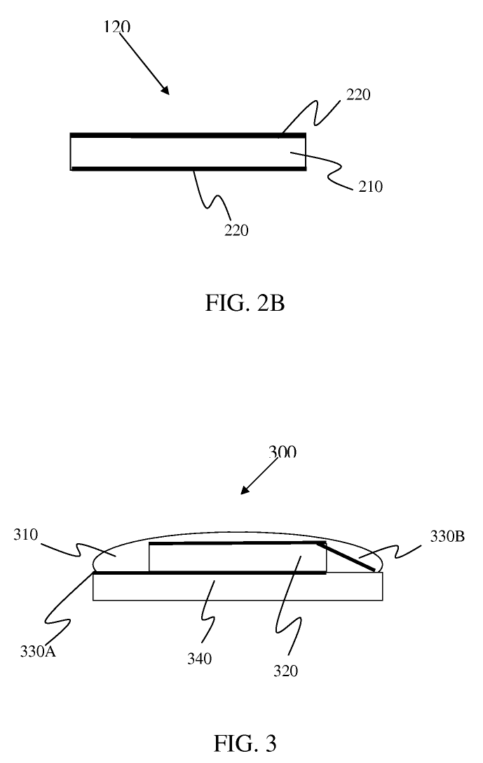

Referring to FIG. 3, a schematic cross-sectional view of a composite chip varistor device 300 according to another embodiment of the present invention is shown. The composite chip varistor device 300 may be fabricated by thick film printing. The manufacturing method of the composite chip varistor device 300 is described as follows. First, a PCB 340 is prepared, and a conductive layer is printed thereon to form an end electrode 330A. Next, an inner varistor 320 is placed at the middle position. Afterwards, an insulating material is covered around the inner varistor 320, and a conductive layer is printed thereon to form the other end electrode 330B. Finally, an insulating material is printed to form an upper layer. Thereafter, the whole structure is sintered or cured at a temperature of 200° C. to 1000° C., so as to form the body 310. The end electrodes 330A, 330B are made of a metal material of Ag, Pd, Pt, Cu, or an alloy material thereof. The thickness of the end electrodes is 0.1 μm to 1 mm. The body 310 is made of an insulating ceramic material or a polymer material, which is sintered or cured at a temperature of 200° C. to 1000° C., such that the body is a highly insulative and imporous mono-material.

Compared with the prior arts, the designs and fabricating methods of the composite chip varistor device of the present invention have the following advantages.

1. In the present invention, the inner varistor is first sintered to attain the designed variable characteristic, and then disposed in a highly insulative and imporous chip, so as to be directly electroplated without adding the coating process. As a result, the cost can be effectively reduced.

2. According to the present invention, the body of the composite chip varistor device can provide protection for the inner varistor so as to avoid being damaged by external factors.

Though the present invention has been disclosed above by the embodiments, they are not intended to limit the present invention. Equivalent modifications and variations made based on the claims of the present invention fall within the scope of the present invention.

### LIST OF REFERENCE NUMERALS

100, 300 composite chip varistor device

110, 310 body

110A lower layer of the body

110B interlayer of the body

110C upper layer of the body

120, 320 inner varistor

130A, 130B end electrode

330A, 330B end electrode

210 varistor strip

220 inner electrode

340 PCB substrate

We claim:

1. A varistor device, comprising:
a body;
an inner varistor having two ends, disposed in the body; and
two end electrodes, disposed at the two ends of the varistor;
wherein the body is a highly insulative and imporous mono-material.

2. The varistor device as claimed in claim 1, further comprising at least one inner electrode disposed between the inner varistor and the end electrodes.

3. The varistor device as claimed in claim 1, wherein the body is a ceramic.

4. The varistor device as claimed in claim 2, wherein the body is a ceramic.

5. The varistor device as claimed in claim 1, wherein the body is a polymer.

6. The varistor device as claimed in claim 2, wherein the body is a polymer.

7. The varistor device as claimed in claim 1, wherein the body is a highly insulative and imporous mono-material.

8. The varistor device as claimed in claim 2, wherein the body is a highly insulative and imporous mono-material.

9. The varistor device as claimed in claim 1, wherein the inner varistor is a combination of one or more varistor strip.

10. The varistor device as claimed in claim 2, wherein the inner varistor is a combination of one or more varistor strip.

11. The varistor device as claimed in claim 1, wherein the inner varistor is a combination of a plurality of varistor strips.

12. The varistor device as claimed in claim 2, wherein the inner varistor is a combination of a plurality of varistor strips.

13. The varistor device as claimed in claim 9, wherein the varistor strip is a Pr base ZnO chip varistor.

14. The varistor device as claimed in claim 10, wherein the varistor strip is a Pr base ZnO chip varistor.

15. The varistor device as claimed in claim 11, wherein the varistor strip is a Pr base ZnO chip varistor.

16. The varistor device as claimed in claim 12, wherein the varistor strip is a Pr base ZnO chip varistor.

17. The varistor device as claimed in claim 9, wherein the varistor strip is a Bi₂O₃ base ZnO chip varistor.

18. The varistor device as claimed in claim 10, wherein the varistor strip is a Bi₂O₃ base ZnO chip varistor.

19. The varistor device as claimed in claim 11, wherein the varistor strip is a Bi₂O₃ base ZnO chip varistor.

20. The varistor device as claimed in claim 12, wherein the varistor strip is a Bi₂O₃ base ZnO chip varistor.

21. The varistor device as claimed in claim 9, wherein a thickness of the varistor strip is 10 μm to 1 mm.

22. The varistor device as claimed in claim 10, wherein a thickness of the varistor strip is 10 μm to 1 mm.

23. The varistor device as claimed in claim 11, wherein a thickness of the varistor strip is 10 μm to 1 mm.

24. The varistor device as claimed in claim 12, wherein a thickness of the varistor strip is 10 μm to 1 mm.

25. The varistor device as claimed in claim 1, wherein the end electrodes are made of a metal material of Ag, Pd, Pt, or an alloy material thereof.

26. The varistor device as claimed in claim 2, wherein the end electrodes are made of a metal material of Ag, Pd, Pt, or an alloy material thereof.

27. The varistor device as claimed in claim 2, wherein the inner electrode is made of a metal material of Ag, Pd, Pt, or an alloy material thereof.

28. The varistor device as claimed in claim 1, wherein a thickness of the end electrodes is 0.1 μm to 1 mm.

29. The varistor device as claimed in claim 2, wherein a thickness of the inner electrode is 10 nm to 0.5 mm.

30. The varistor device as claimed in claim 1, wherein the varistor is sintered at a temperature above 1000° C.

31. A method of manufacturing a composite chip varistor device, comprising:
forming a varistor having two ends;
forming a plurality of end electrodes at the two ends of the varistor;
forming a body having a highly insulative and imporous mono-material; and
combining the varistor and the plurality of end electrodes in the body.

32. The method as claimed in claim 31, wherein the end electrodes are made of a metal material of Ag, Pd, Pt, or an alloy material thereof.

33. The method as claimed in claim 31, wherein the plurality of end electrodes is formed at the two ends of the varistor by multilayer printing.

34. The method as claimed in claim 31, wherein the plurality of end electrodes is formed at the two ends of the varistor by thick film printing.

35. The method as claimed in claim 31, wherein the plurality of end electrodes is formed at the two ends of the varistor by printed circuit board (PCB) printing.

36. The method as claimed in claim 31, wherein the varistor is combined in the body by lamination.

37. The method as claimed in claim 31, wherein the composite body is sintered or cured at a temperature of 250° C. to 1000° C., such that the body is a highly insulative and imporous mono-material.

38. The method as claimed in claim 31, further comprising:
forming a plurality of inner electrodes between the varistor and the plurality of end electrodes.

39. The method as claimed in claim 38, wherein the inner electrode is made of a metal material of Ag, Pd, Pt, or an alloy material thereof.

40. The method as claimed in claim 38, wherein the plurality of inner electrodes is formed between the varistor and the plurality of end electrodes by multilayer printing.

41. The method as claimed in claim 38, wherein the plurality of inner electrodes is formed between the varistor and the plurality of end electrodes by thick film printing.

42. The method as claimed in claim 38, wherein the plurality of inner electrodes is formed between the varistor and the plurality of end electrodes by PCB printing.

43. The method as claimed in claim 31, wherein the composite body is sintered or cured at a temperature of 250° C. to 1000° C., such that the body is a highly insulative and imporous mono-material.
